(19) United States
(12) Patent Application Publication
(10) Pub. No.: US 2008/0276468 A1
(43) Pub. Date: Nov. 13, 2008

(54) Knife

(75) Inventor: Tore Norling, Vamhus (SE)

Correspondence Address: DILWORTH & BARRESE, LLP, 333 EARLE OVINGTON BLVD., SUITE 702, UNIONDALE, NY, 11553, US

(73) Assignee: MORA OF SWEDEN, Mora (SE)

(21) Appl. No.: 11/664,314

(22) PCT Filed: Sep. 30, 2004
(86) PCT No.: PCT/SE04/01400

§ 371 Date: Mar. 30, 2007

(51) Int. Cl. B26B 3/00; B25G 1/00

(52) U.S. Cl. 30/343; 30/350; 30/340; 16/430; 76/104.1

(57) ABSTRACT

A knife intended for cutting in food, especially meat, such as for slaughtering or cutting into pieces, has a knife blade (8) of steel provided with an edge and a handle (11) receiving the rod (10) thereof. The handle bears, at least in the region (12) adjoining to the part (9) of the blade provided with the edge, surrounding and against the rod (10) of the blade through a first material able to adhere intimately to the steel of the blade and thereby tightening connection.

### FIELD OF THE INVENTION AND PRIOR ART

The present invention relates to a knife intended for cutting in food, especially meat, such as for slaughtering or for cutting into pieces, which has a knife blade of steel provided with an edge and a handle receiving the rod thereof.

The invention relates to all types of knives intended for cutting in food, but for better illuminating the invention and the problems associated with this type of knives and which the invention intends to solve, this will hereinafter be described for knives used within handling of meat, such as in slaughterhouses for slaughtering and/or for cutting into pieces, without restricting the invention thereto.

For making the handle of such knives stiff any hard material is normally used for receiving the rod of the blade and prolonging the handle beyond this rod. A softer material may then possibly be arranged externally of the harder material for making the handle comfortable to grip by the hand. When plastic is used as the harder material this may for example be any type of polypropene.

Such a knife already known is illustrated in the enclosed FIG. 1 and FIG. 2. This knife has in the handle 1 thereof closest to the rod 3 of the blade 2 a material layer 4 of hard plastic, such as reinforced polypropene. This material has no real bonding to the steel of the blade, so that already at the beginning of the use thereof the handle gets loose on certain locations from the blade in the region closest to the part 5 of the blade provided with an edge. This means that in the transition between this blade part 5 provided with an edge and the handle small pockets 6 are formed. Especially when cutting meat such a knife is subjected to high loads increasing the risk that the hard plastic material loosens more from the blade on certain locations and considerable such pockets are formed. Liquid and particles from the meat penetrate into these pockets 6, even such pockets there after the manufacturing of a knife, when cutting into the meat. It may be difficult to completely remove this penetrating material by dishwashing, so that there is a great risk that bacteria thrive in these pockets and are transferred to the meat upon later handling of meat by the knife. This is a problem not realised yet which the present inventor has realised.

### SUMMARY OF THE INVENTION

The object of the present invention is to provide a knife of the type mentioned in the introduction, which makes it possible to solve the problem discussed above of such knives already known.

This object is according to the invention obtained by the fact that in such a knife the handle at least in the region adjoining to the part of the blade provided with the edge surroundingly bears upon the rod of the blade through a first material able to adhere intimately to the steel of the blade and by that tightening thereagainst. By arranging such a material layer in said region around the rod of the blade tightness may be ensured between the handle and the blade, so that no material from for example meat cut by the knife may penetrate into any cavity between the handle and the blade. The knife will by that be easy to clean without any risk of remaining material and bacteria growth. This first material is advantageously comparatively soft, or in any case of the nature that it follows the knife blade in a continuous tight bonding thereto even at that type of movements to which the blade may be subjected.

According to a preferred embodiment of the invention said material is a material able to wet to the surface of the steel of the blade. This means an extremely intimate bonding of this material to the steel of the blade, so that the first material gets in principle integrated with the steel at the interface therebetween and tightens completely to the steel.

According to another preferred embodiment of the invention said first material is arranged in the form of a layer of the handle by means of which the handle bears against the rod of the blade. The arrangement of the first material for tightening between the handle and the blade is through such a layer obtainable in a very advantageous way as seen from the manufacture technique point of view with respect to how the handle, primarily the plastic material, for the rest traditionally is arranged on the rod of the blade of knives of this type.

According to another preferred embodiment of the invention said material is a plastic material, and especially a thermoplastic elastomer on ethylene base. It has been found that exactly such a type of plastic material is able to adhere that intimately to steel used for knife blades that any risk of penetrating of liquid or solid material between this plastic material and the steel may be eliminated.

According to another preferred embodiment of the invention said plastic material is the plastic material (X8291-85TL) marketed under the trademark SANTOPRENE®. This plastic material has turned out to wet to the surface of steels used for knife blades, stainless steel as well as carbon steel, and solve the problem realised by the inventor in an excellent way. Another advantage of this material is that it is admitted for handling food, i.e. in the practise admitted by among others FDA (The Food Authority of The United States), since it meets the requirements of FDA of rubber articles intended for repeated use.

The invention relates, as mentioned, to both knives having blades of stainless steel and of carbon steel.

According to another preferred embodiment of the invention the entire handle is of plastic material, and the handle comprises externally of the layer of the first material a layer of a further plastic material able to bond tightly to said first plastic material. Thus, the unique property of the first plastic material of a knife according to this embodiment is that it adheres intimately on one hand to the steel of the blade and on the other to said further plastic material, so that no food remainders may neither penetrate there and get stuck with a risk of bacteria growth. This means that it gets possible to have a layer of another material outside of the layer of said first plastic material in the region of the handle closest to the part of the blade provided with the edge, which may be advantageous for several reasons, for example so as to stiffen the handle and obtain a steady connection between the handle and the blade.

According to a further development of the embodiment last mentioned the handle comprises a layer surrounding said rod of a hard plastic material stiffening the handle and arranged externally of the layer of said first plastic material in said region and which is able to bond tightly thereto and prolongs the handle substantially beyond the end of the rod. A hard handle is by this obtained by using a plastic material even when using a first plastic material having a soft nature.

According to another embodiment of the invention said hard plastic material is formed by a glass reinforced polypropene.

According to a further embodiment of the invention the handle comprises a third layer of a soft plastic material arranged externally of the layer of the hard plastic so as to make the handle comfortable to grip by the hand. It is also possible that in this case the third layer extends in the direction of the part of the blade provided with the edge longer than the layer of the hard plastic material and connects to said first plastic material beyond the hard plastic material and bonds tightly to this first plastic material for preventing food remainders to penetrate between these material layers. It is in such a case not even necessary that the first plastic material and the hard plastic material are able to adhere intimately to each other, but it is sufficient that the first plastic material is adapted to adhere intimately in the required way mentioned above to the soft plastic material of the third layer.

According to another preferred embodiment of the invention the rod of the blade is adapted to extend substantially through the entire handle for stiffening thereof, and a soft plastic material, which bonds tightly to the first plastic material, is arranged externally of said first plastic material and the rod for making the handle comfortable to grip by the hand. This is a possible embodiment of a knife according to the invention, which obtains stiffness of the handle without any requirement to use any hard material for the handle. It is in this case possible that the first plastic material is arranged to completely surround the rod of the blade and form a layer separating the rod and said layer of soft plastic material. However, this is not completely necessary, but said soft plastic material could connect directly to the rod in the region thereof at a distance from the transition between the handle and the part of the blade provided with the edge.

The invention also relates to a method for manufacturing a knife according to the invention, in which the layer of said first plastic material is applied to the rod of the knife blade by firstly cleaning the rod, then or at the same time heating it to an elevated temperature, after that placing it in a moulding tool and then injection-moulding said first plastic material around the rod having an elevated temperature. It has turned out that such an injection-moulding of the first plastic material on the rod of the knife blade at an elevated temperature of the knife blade results in an extremely intimately adherence of the first plastic material to the steel of the knife blade and a reliable achievement of the properties aimed at of the knife according to the invention.

Further advantages as well as advantageous features of the invention appear from the following description and the other dependent claims.

### BRIEF DESCRIPTION OF THE DRAWING

With reference to the appended drawing, below follows a specific description of preferred embodiments of the invention cited as examples.

In the drawing:

FIG. 1 is a simplified side elevation of a knife already known of the type according to the invention,

FIG. 2 is a detail view of the transition between the part of the blade provided with an edge and the handle of the knife already known according to FIG. 1,

FIG. 3 is a partially sectioned view of a knife according to a first embodiment of the invention, and

FIG. 4 is a partially sectioned view of a knife according to a second embodiment of the invention.

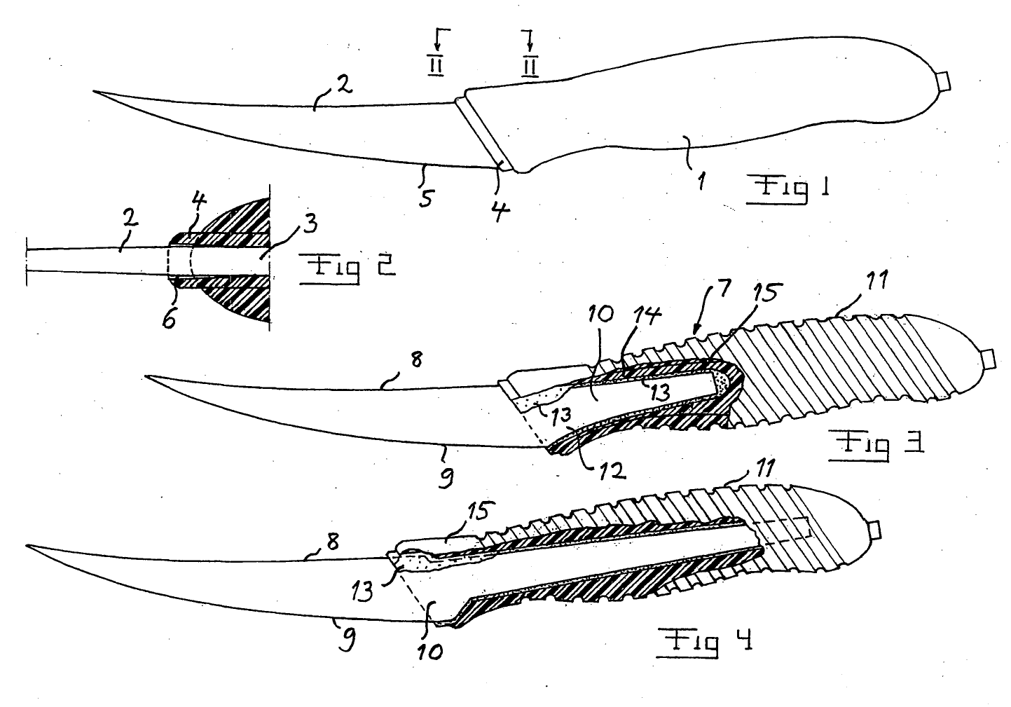

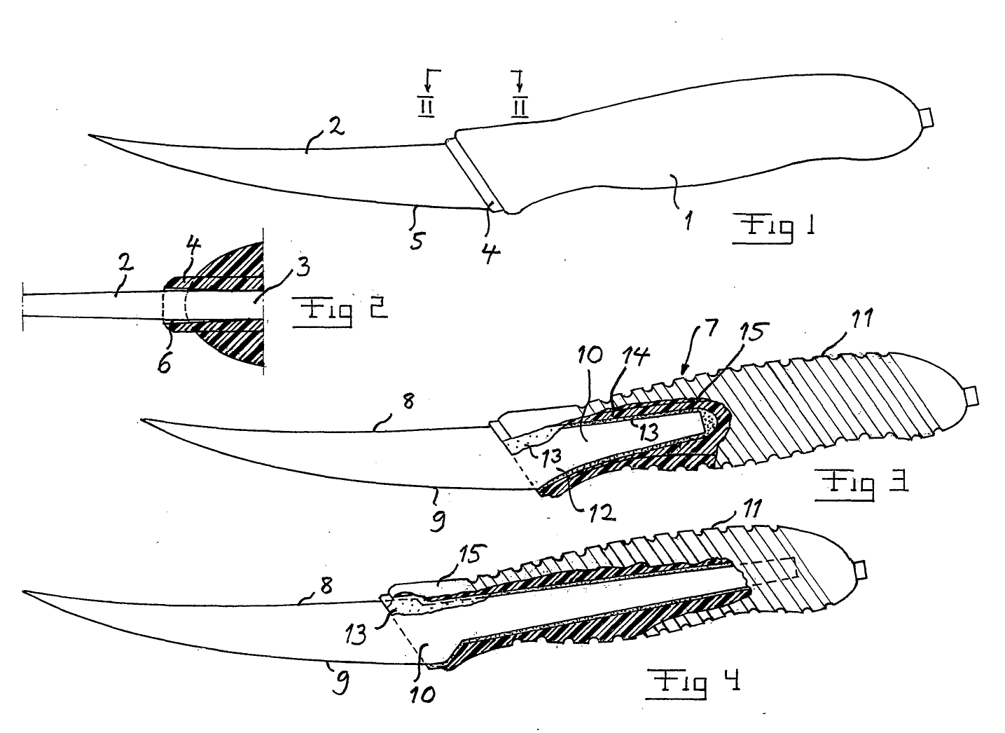

### DETAILED DESCRIPTION OF PREFERRED EMBODIMENTS OF THE INVENTION

A partially sectioned view of a knife 7 according to a preferred embodiment of the invention is shown in FIG. 3. This knife is intended to be used for cutting in meat, primarily in slaughter-houses, for slaughtering and/or cutting into pieces. The knife has a knife blade 8, which has a part 9 provided with an edge and a rod 10, as well as a handle 11 adapted to receive said rod 10 and function as a handle for the person who has to handle the knife.

The blade 8 is preferably of stainless steel, but also carbon steel is possible. The handle 11 bears in the region 12 adjoining to the part 9 of the blade provided with the edge against the rod 10 of the blade through a layer 13 of a first plastic material able to wet to the surface of the steel of the blade so as to adhere intimately and absolutely tightly to this surface. A preferred material for this layer 13 is the thermoplastic elastomer on ethylene basis marketed under the trademark SANTOPRENE® (X8291-85TL), which is provided by the United States company Advanced Elastomer Systems L.P. A second layer 14 of a hard plastic material stiffening the blade is arranged externally of the layer of the first material. This second layer 14 may for example be a glass reinforced polypropene and prolongs the handle substantially beyond the end of the rod, so that said rod does not have to be that long and the entire rod will nevertheless be stiff.

Said first plastic material is also able to adhere intimately to and by that tightening against the material of the second layer 14.

A third layer 15 of a soft plastic material is arranged externally of the second layer 14 so as to make the handle comfortable to grip by the hand. The first plastic material of the first layer 13 is able to adhere intimately to and by that tightening against this third soft plastic material, which at the handle end closest to the part 9 provided with the edge may extend longer than the second layer 14 and connect directly to the first layer 13 of the first plastic material, although it here is terminated longer away from the part 9 than the second layer.

Thanks to the fact that the first plastic material, here the thermoplastic elastomer on ethylene base, is able to adhere on one hand to steel (the blade) and on the other to plastic (the second and third layer) the formation of the pockets mentioned above is avoided in the border region between the handle and the blade part provided with the edge. Thanks to this ability of said first plastic material the knife will with respect to tightness in this region instead function as if the entire knife with blade and handle would be an integrated part moulded as one single piece.

A knife according to a second embodiment of the invention is shown in FIG. 4. The parts also present in the embodiment according to FIG. 3 have in this figure been provided with the same reference numerals, and only the differences between these two knives will here be described. This embodiment differs from that according to FIG. 3 by the fact that there is no second layer of a hard plastic material stiffening the handle, but the handle receives here sufficient stiffness by the extension of the rod 10 of the blade substantially through the entire handle. Thus, the third layer 15 of soft plastic material is here arranged directly upon the layer 13 of the first plastic material.

The manufacture of the knife with respect to the application of the handle on the blade takes place according to an embodiment of the invention in the following way: the knife blade and the rod thereof are firstly cleaned. The rod of the knife blade is then or simultaneously heated to an elevated temperature and is preferably carefully flamed so as to burn away possible remainders of wax from earlier polishing of the blade. The rod of the knife blade is then arranged in a moulding tool and said first plastic material is then injection-moulded around the rod still having an elevated temperature of preferably 100-120° C. in the case of SANTOPRENE®. The rod of the knife blade is removed from the moulding tool when the first plastic material has solidified and it is placed in a new moulding tool for injection-moulding of the second layer externally thereof and when this has solidified to a still further moulding tool for injection-moulding of the third layer. In the case of absence of the second layer that step of the method is of course not carried out. The heating and the flaming of the blade is preferably carried out in one and the same operation by heating under a gas flame. The heating is a condition when the blade has been previously polished. Polish wax remains in such a case on the blade, so that it has to be heated for removing the wax. The first plastic material will not wet to the steel of the blade until the wax is gone.

The invention is of course not in any way restricted to the preferred embodiments described above, but many possibilities to modifications thereof would be apparent to a person with skill in the art without departing from the basic idea of the invention.

The layer of the first plastic material is only necessary for connecting the handle to the blade in said region, where the handle adjoins to the part of the blade provided with the edge, and this layer could extend considerably shorter in the direction towards the other handle end than shown in the figures. Any of the other layers will then connect to the rod where it is not critical that the connection is completely intimate and constant over the time.

Even if it is advantageous to have a said blade layer of said first material so as to obtain the tightening aimed at, it is within the scope of the invention to instead achieve this for example by obtaining that the handle bears against the rod of the blade in said region around the blade through a said first material in the form of for example any type of glue or the like. However, that solution would probably be somewhat more difficult to realise from the manufacturing technique point of view. It is at the same time important that the first material used is suitable for handling food. Thus, the first material belongs in this case not to the very handle, but also such glue or the like forms in a way an extension of the handle in the region adjoining to the part provided with the edge. Thus, also this type of tightening is covered by the patent claim definition “that the handle surroundingly bears against the rod of the blade through a first material at least in the region adjoining to the part of the blade provided with the edge”.

1. A knife intended for cutting in food, especially meat, such as for slaughtering or cutting into pieces, which has a knife blade (8) of steel provided with an edge and a handle (11) receiving the rod (10) thereof, wherein
the handle (11) bears at least in the region (12) adjoining to the part (9) of the blade (8) provided with the edge surroundingly upon the rod (10) of the blade (8) through a first material able to adhere intimately to the steel of the blade (8) and by that tightening thereagainst.

2. A knife according to claim 1, wherein said first material is a material able to wet to the surface of the steel of the blade (8).

3. A knife according to claim 1, wherein said first material is arranged in the form of a layer (13) of the handle (11) by which the handle (11) bears against the rod (10) of the blade (8).

4. A knife according to claim 3, wherein the first material is a plastic material.

5. A knife according to claim 4, wherein said plastic material is a thermoplastic elastomer on ethylene base.

6. A knife according to claim 5, wherein said plastic material is a plastic material (X8291x-85TL) marketed under the trademark SANTOPRENE®.

7. A knife according to claim 1, wherein said blade (8) is made of stainless steel or carbon steel.

8. A knife according to claim 4, wherein the entire handle (11) is made of plastic material, and the handle (11) comprises externally of the layer (13) of the first material a layer of a further plastic material (14, 15) able to bond tightly to said first plastic material.

9. A knife according to claim 8, wherein the handle (11) comprises a layer (14) surrounding said rod (10) of a hard plastic material stiffening the handle (11) and arranged externally of the layer (13) of said first plastic material in said region and which is able to bond tightly thereto and prolongs the handle (11) substantially beyond the end of the rod (10).

10. A knife according to claim 9, wherein said hard plastic material is constituted by a glass reinforced polypropene.

11. A knife according to claim 9, wherein the handle comprises a third layer (15) of a soft plastic material arranged externally of the layer (14) of the hard plastic so as to make the handle (11) comfortable to grip by the hand.

12. A knife according to claim 4, wherein the rod (10) of the blade (8) is positioned to extend substantially through the entire handle (11) for stiffening thereof, and a layer (15) of a soft plastic material, which bonds tightly to the first plastic material, is arranged externally of said first plastic material and the rod for making the rod comfortable to grip by hand.

13. A knife according to claim 12, wherein said first plastic material is positioned to completely surround the rod (10) of the blade (8) and form a layer separating the rod (10) and said layer (15) of soft plastic material.

14. A knife according to claim 1, formed as a slaughter knife or a knife for cutting into pieces.

15. A method for producing a knife according to claim 4, wherein the layer of said first plastic material is applied to the rod (10) of the knife blade (8) by firstly cleaning the rod (10),
then or at the same time, heating it to an elevated temperature,
after that, placing it in a moulding tool and then injection-moulding said first plastic material around the rod (10) having an elevated temperature.

16. A knife according to claim 2, wherein said first material is arranged in the form of a layer (13) of the handle (11) by which the handle (11) bears against the rod (10) of the blade (8).

17. A knife according to claim 10, wherein the handle comprises a third layer (15) of a soft plastic material arranged externally of the layer (14) of the hard plastic so as to make the handle (11) comfortable to grip by hand.

18. A knife according to claim 5, wherein the entire handle (11) is made of plastic material, and the handle (11) comprises, externally of the layer (13) of the first material, a layer of a further plastic material (14, 15) able to bond tightly to said first plastic material.

19. A knife according to claim 6, wherein the entire handle (11) is made of plastic material, and the handle (11) comprises, externally of the layer (13) of the first material, a layer of a further plastic material (14, 15) able to bond tightly to said first plastic material.

20. A knife according to claim 5, wherein the rod (10) of the blade (8) is positioned to extend substantially through the entire handle (11) for stiffening thereof, and a layer (15) of a soft plastic material, which bonds tightly to the first plastic material, is arranged externally of said first plastic material and the rod for making the rod comfortable to grip by hand.
